(19) United States
(12) Patent Application Publication
(10) Pub. No.: US 2009/0138317 A1
(43) Pub. Date: May 28, 2009

(54) Connecting Providers of Financial Services

(76) Inventor: Roy Schoenberg, Boston, MA (US)

Correspondence Address: FISH & RICHARDSON PC, P.O. BOX 1022, MINNEAPOLIS, MN, 55440-1022, US

(21) Appl. No.: 12/270,224

(22) Filed: Nov. 13, 2008

Related U.S. Application Data
(63) Continuation-in-part of application No. 11/763,680, filed on Jun. 15, 2007.
(60) Provisional application No. 60/824,966, filed on Sep. 8, 2006.
(60) Provisional application No. 60/828,921, filed on Oct. 10, 2006.
(60) Provisional application No. 60/828,924, filed on Oct. 10, 2006.
(60) Provisional application No. 60/829,139, filed on Oct. 11, 2006.
(60) Provisional application No. 60/829,140, filed on Oct. 11, 2006.

(51) Int. Cl. G06Q 10/00; G06F 15/16; G06Q 40/00

(52) U.S. Cl. 705/9; 705/1; 709/206; 705/35

(57) ABSTRACT

In general, in one aspect, a real-time communication between a consumer of services and a provider of financial services is brokered using a brokerage system on a computer by: receiving a request from the consumer of services to consult with a provider of financial services; identifying an available provider of financial services; and activating a communication channel between the consumer of services and the available provider of financial services. Providers of financial services include, but are not limited to, an account, a tax professional, or a financial advisor.

### CLAIM OF PRIORITY

This application is a continuation-in-part and claims priority under 35 USC §120 to U.S. patent application Ser. No. 11/763,680, filed Jun. 15, 9007, which in turn claims priority under 35 USC §119(e) to provisional U.S. Patent Applications 60/824,966, filed Sep. 8, 2006, 60/828,921, filed Oct. 10, 2006, 60/828,924, filed Oct. 10, 2006, 60/829,139, filed Oct. 11, 2006, and 60/829,140, filed Oct. 11, 2006, the entire contents of each of which are hereby incorporated by reference.

### BACKGROUND

The present disclosure is directed to connecting consumers with providers of services, such as financial services

Systems have been developed to connect consumers and their providers over the Internet and the World Wide Web. Some systems use e-mail messaging and web-based forms to increase the level of connectivity between a member of a plan and his assigned provider. The consumer sends an e-mail or goes to a website that generates and sends a message (typically an e-mail or an e-mail type message) to a local provider.

### SUMMARY

One of the advantages of the brokerage system described herein is that a consumer and a provider of financial services engage in a real time communication.

In general, in one aspect, a real-time communication between a consumer of services and a provider of financial services is brokered using a brokerage system on a computer by: receiving a request from the consumer of services to consult with a provider of financial services; identifying an available provider of financial services; and activating a communication channel between the consumer of services and the available provider of financial services. Providers of financial services include, but are not limited to, an account, a tax professional, or a financial advisor.

In some examples, a first graphical user interface is provided that when rendered on a display displays for the consumer types of available providers of financial services. A request is received from the consumer of services to consult with a selected type of provider of financial services; and a second graphical user interface is provided that when rendered on the display displays for the consumer areas of specialization for the selected type of provider of financial services. The identification of an available provider of financial services further comprises monitoring availability of the providers of financial services. Additionally, a request is received from a consumer of services to consult with a provider of financial services having a provider profile that satisfies at least some attributes in a set of attributes that define a suitable provider of financial services. In some examples, a message is received from a consumer of services; the contents of the message are parsed; and a type of provider of professional services is identified to consult with the consumer based on the results of the parsing.

### BRIEF DESCRIPTION OF THE FIGURES

FIG. 1 is a diagrammatic view of an engagement brokerage service.

FIGS. 2A, 5A-5D, 7, 8, and 10 are screen images of a user interface for an engagement brokerage service.

FIG. 2B is a flow chart for an interactive voice response system interface for an engagement brokerage service.

FIGS. 3, 4A-4D, 6, 12, 13, 17 are flow charts of processes used in an engagement brokerage system.

FIG. 9 is a table of sample criteria used in an engagement brokerage system.

FIG. 11 is a diagram of a brokerage system connecting consumers with service providers.

FIGS. 14, 15, 16 are flowcharts of various types of providers of financial services.

### DETAILED DESCRIPTION

### Overview

The system described below provides an integrated information and communication platform that enables consumers of services to identify and prioritize service providers, such as providers of financial services, with whom they should consult and to carry out consultations with such service providers in an efficient manner. Consumers are able to consult on-line with an expert service provider, at a mutually convenient time and place, even when the two parties are geographically separated. This integrated platform is referred to herein as an engagement brokerage service (brokerage).

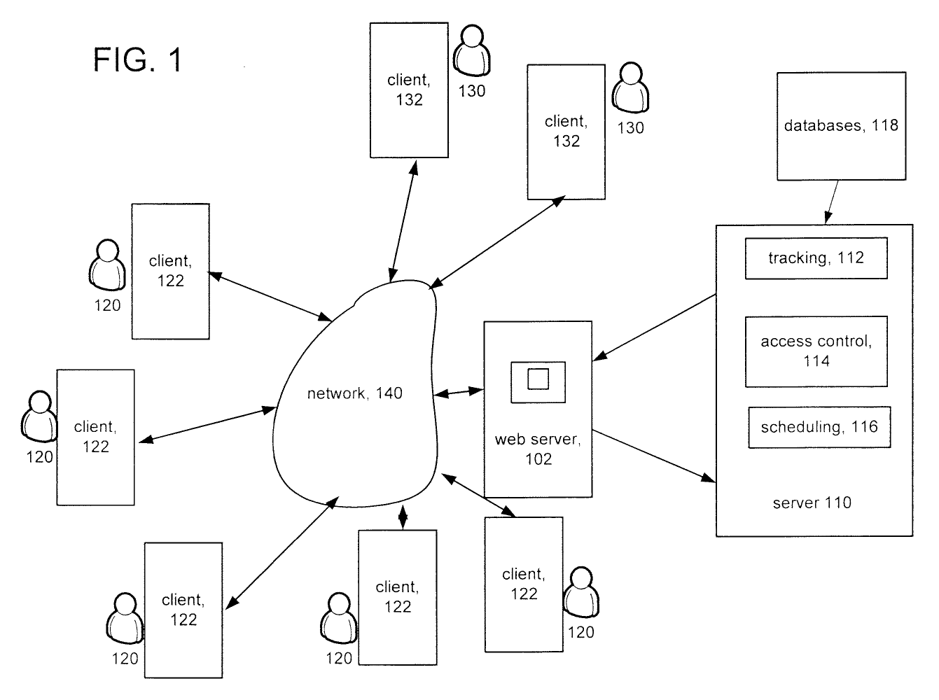

FIG. 1 shows an example system 100 implementing the brokerage service. The system 100 includes a computerized system or server 110 for making connections between consumers 120, at client systems 122, and service providers 130, at client systems 132, over a network 140, e.g., the Internet or other types of networks. The computerized system 110 may operate as a service running on a web server 102.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider may be contacted. In some examples of an active system, the provider's computer, phone, or other terminal device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art.

Using the system 100, a consumer 120 communicates with a provider 130. The consumers 120 and providers 130 connect to the computerized system 110 through a website or other interface on the web server 102 using client devices 122 and 132, respectively. Client devices 122 and 132 can be any combination of, e.g., personal digital assistants, land-line telephones, cell phones, computer systems, media-player-type devices, and so forth. The client devices 122 and 132 enable the consumers 120 to input and receive information as well as to communicate via video, audio, and/or text with the providers 130.

Limited by business hours and other clients, providers struggle with the idea of adding another service commitment to their existing workload. Clients sending queries to their providers can not expect an immediate response and are often asked to schedule an appointment for further evaluation. Providers are, however, often available at times that are not convenient for their clients, for example, in the event of a last-minute cancellation. Providers also may be available for e-visits during otherwise idle times, such as when home, during their commute, and so forth. The brokerage supplements existing provider availability to allow whichever providers are available at any given time to provide e-visits to whichever consumers need a consultation at that time. Instead of relying on the unlikely availability of a specific provider for any given consumer, the brokerage connects the consumer to all online providers capable of addressing the consumer's needs. The brokerage has distinct features including the ability to engage in live communication with a suitable, selectable provider and the ability to do so on-demand.

One advantage that the brokerage provides is that the brokerage constantly monitors the availability of a provider for an engagement and thus, consumers receive immediate attention to address their questions or concerns, since the brokerage will connect them to available service providers. In order to achieve such a level of availability, the system assimilates the discretionary or fractional availability windows of time offered by individual providers into a continuous availability perception by consumers. Since many of the services offered to consumers are on-demand, consumers have little expectation that the same provider will be constantly available, rather, they expect that some provider will be available.

The computerized system 110 provides information and services to the consumers 120 in addition to connecting them with providers 130. The computerized system 110 includes an access control facility 114, which manages and controls whether a given consumer 120 may access the system 110 and what level or scope of access to the features, functions, and services the system 110 will provide.

The consumer 120 uses the system 100 to find out more information about a topic of interest or, for example, an area of finance, such as one relating to 401Ks or IRAs and so forth. The computerized system 110 identifies service providers 130 that are available at any given moment to communicate with a consumer about a particular product, service, topic or subject. The computerized system 110 facilitates communication between the consumer 120 and provider 130, enabling them to communicate, for example, via a data-network-facilitated video or voice communication channel (such as Voice over IP), land and mobile telephone network channels, and instant messaging or chat. In some examples, the availability of one or more providers 130 is tracked, and at the instant a consumer 120 desires to connect and communicate with a provider, the system 110 determines whether a provider is available. If a particular provider 130 is available, the system 110 assesses the various modes of communication that are available and connects the consumer 120 and the provider 130 through one or more common modes of communication.

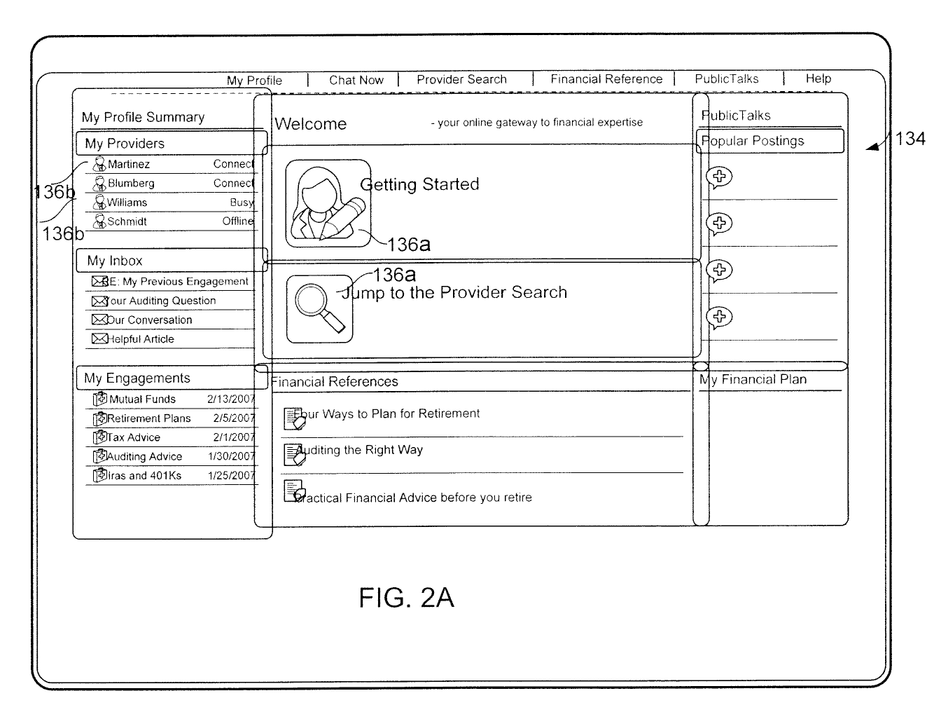

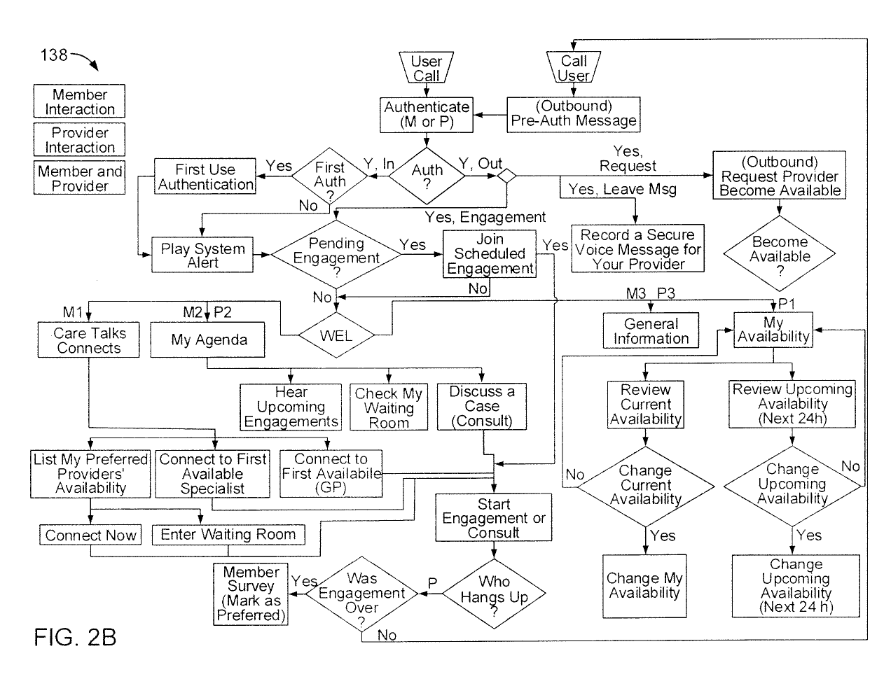

The system selects a mode of communication to use based in part on the relative utility of the various modes. The preferred mode for an engagement is for both the consumer 120 and the provider 130 to use web-based consoles, as this allows each of the other modes to be used as needed. For example, consumers and providers may launch chat sessions, voice calls, or video chats from within a web-based console like that shown in FIG. 2A, below. A web based console also provides on-demand access to records, such as the consumer's financial history, and other information. If only one of the participants in an engagement has access to a web console, the system 110 connects that participant's console to whatever form of communication the other party has available. For example, if the consumer is on the phone and the provider is using a web browser, the system 110 may connect the consumer's phone call to a VoIP session that the provider can access through the web.

If the provider 130 is not available, the system 110 identifies other available providers 130 that would meet the consumer 120's needs. The system 110 enables the consumer 120 to send a message to the consumer's chosen provider. The consumer can also have the system 110 contact the consumer in the future when the chosen provider is available.

By way of illustration, the system 100 connects members of financial plans with providers of financial products and services. As described herein, service providers include providers of financial services, including tax professionals, financial advisors and accountants. For example, the service providers 130 may be physicians, and the service consumers 120 may be clients. The service providers and service consumers may also be lawyers and clients, contractors and homeowners, or any other combination of a provider of services and a consumer of services.

The system enables the consumer to search for providers that are available at the time the consumer is searching and enables the consumer to engage a provider on a transactional basis or for a one-time consultation. A consumer is able to engage a world-renowned financial advisor for a consultation, even though the specialist is located too far away from the consumer to become a regular client, or consumer. The consumer can use that specialist's advice when considering services by a local service provider.

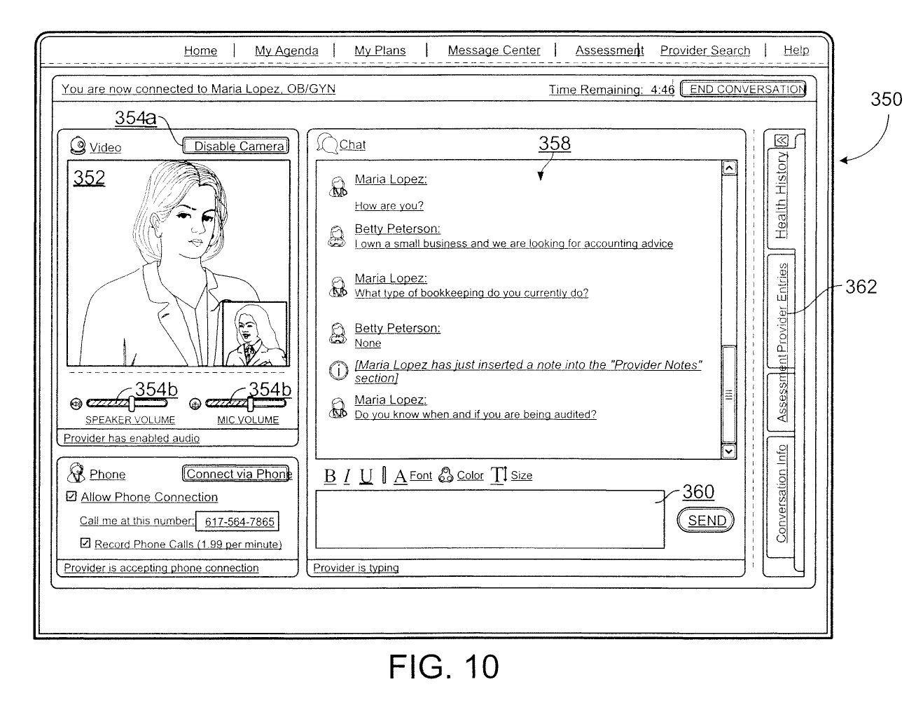

FIG. 2A shows a page 134 of the main user interface to the brokerage. Many of the web-based functions are also provided by an Interactive Voice Response (IVR) system, as discussed below. As noted the server 110 sends web pages like the page 134 to the consumer 120 and the provider 130 and receives responses from the consumer 120 and the provider 130. In some examples, the application server provides a predefined sequence of web pages or voice prompts to the consumer 120 or the provider 130. FIG. 2 shows an interface intended for the consumer 120. A similar interface is provided for providers 130, as shown in FIG. 10.

The web page 134 includes various elements to enable the consumer 120 (to input information. These interface elements include buttons 136a and text 136b to enable the consumer 120 to select information and to navigate the website. Other standard elements (not shown) can include text boxes to receive textual information and menus (such as drop-down menus) to enable the consumer 120 to select information from a menu or list.

Referring now to FIG. 2B, an example of logic for use in an IVR system is shown. It is not intended that FIG. 2B be described in detail, since it is one of many possible logic flows for such a system and the exact details on questions and sequences is not important to an understanding of the concepts disclosed herein. In the IVR system, the voice prompts include questions or statements that elicit information from the consumer 120 and the provider 130 as shown. The consumer 120 and the provider 130 input information by speaking into the microphone of the telephone or other terminal device and their speech is stored as received or converted to text using voice recognition. In some examples, the questions are multiple choice questions and the consumer 120 or the provider 130 responds with spoken responses or by pressing buttons on the keypad of their phone or other terminal device. The IVR system follows a series of flow charts like the flowchart 138 in FIG. 2B and can include a menu system, in which case the consumer 120 or provider 130 moves forward or backward, or exits the system by pressing certain keys.

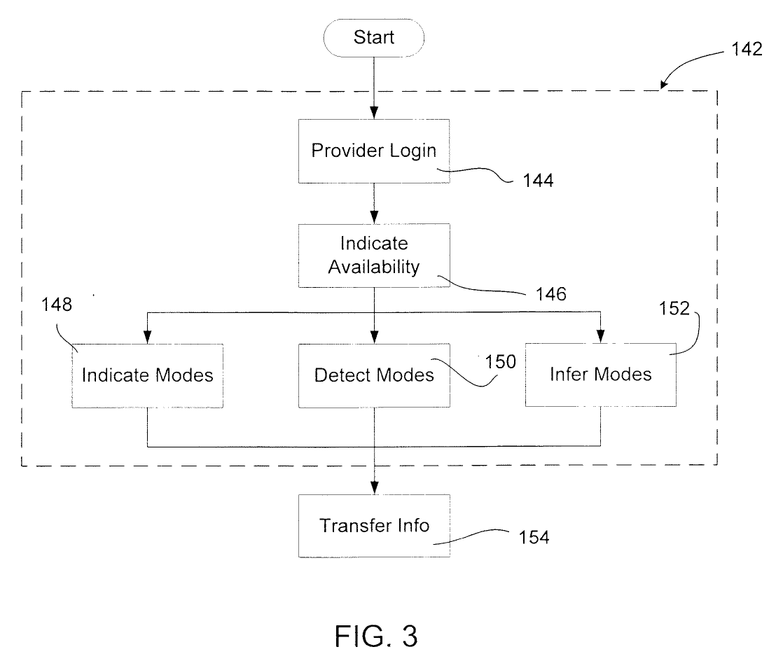

Referring now to FIG. 3, the computerized system 110 tracks 142 the availability of providers 130 and consumers 120. When a provider 130 logs 144 into the system 100, the provider 130 indicates 146 (such as by setting a check box or selecting a menu entry or by responding to a voice prompt) to the tracking module 112 that he or she is available to interact with consumers 120. The provider 130 can also indicate 148 to the tracking module 112 (such as by setting a check box or selecting a menu entry or by responding to a voice prompt) the modes (e.g., telephone, chat, video conference) by which a consumer 120 can be connected to the provider 130. Alternatively, the tracking module 114 determines 150 the capabilities of the terminals 122 and 132 the consumer 120 and the provider 130 use to connect to the system (for example, by using a terminal-based program to analyze the hardware configuration of each terminal). Thus, if a provider 130 connects to the system 100 by a desktop computer and the provider has a video camera connected to that computer, the tracking module 112 determines 150 that the provider 130 can be engaged by text (e.g., chat or instant messenger), voice (e.g., VoIP) or video conference. Similarly, if a provider 130 connects to the system using a handheld device such as a PDA, the tracking module 112 determines 152 that the provider 130 can be engaged by text or voice. The tracking module 112 can also infer 152 a provider's availability and modes of engagement by the provider's previously provided profile information and the terminal device through which the provider connects to the system.

Providers participating in the brokerage network can have several states of availability over time. States in which the provider may be available may include on-line, in which the provider is logged-in and can accept new engagements in any mode, on-line (busy), in which the provider is logged-in but is currently occupied in a video or telephonic engagement, and scheduled, in which the provider is offline but is scheduled to be online at a designated time-point and can pre-schedule engagements for it. While not online, the provider can take messages as in offline state. Other states may include off-line, in which the provider is not logged in but can take message-based engagements (i.e., asynchronous engagements), out-of-office, in which the provider is not accepting engagements or messages, and standby, in which the provider is offline and can be paged to Online status by the brokerage network if traffic load demands it (in some examples, consumers see this state as offline).

The operating business model for the provider network employs a remuneration scheme for providers that helps assure that the consumers can find providers in designated professional domains in the online mode. For example, selected providers can be remunerated for being in the standby mode to encourage their on-line availability in case of low discretionary availability by other providers in their professional domain. Standby providers are also called into the on-line state when the fraction of on-line (busy) providers in their professional domain exceeds a certain threshold. In some examples, the transition of providers from standby to online and back to standby (in case of over capacity or idle capacity) is an automated function of the system.

The tracking module 112 transfers 154 information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

As noted, the system 100 includes access control facilities 114 that control how consumers 120 access the system and to what extent or level the services provided by the system are made available to consumers. The system 100 also stores and provides access to consumer information (e.g., contact information, credit and financial information, consumer's current investment information, and other information related to the consumer and the services purchased or otherwise used by the consumer) and provider information (e.g., provider biographies, product and service information, and any information the provider wants to make available to members) and the access control facility 114 can prevent unauthorized access to this information. In some examples, the system 100 exports the consumer information for use in a provider's office or other facility.

The system 100 interacts with consumers and available data sources to position and direct their matters to appropriate providers. Consumers can use various tools of provider profiling to exercise choice in selecting the providers they wish to interact with. The brokerage facilitates the communication between the consumer and his selected providers, allowing the consumer to follow-up as needed to establish a comfort level in his care. The brokerage supports transfer of these communications and any other results of the eVisit to non-virtual offices and facilities if such escalation is needed.

The brokerage can be considered as a first tier of service that is made available to consumers at home or at other locations. This first tier precedes typical entry points into a consultation setting, e.g., a provider's office. The brokerage enables consumers to explore concerns on, new or existing financial issues without the need to incur the time, cost, and burden of office visits. The system provides immediate access to tools that help define financial issues, as well as, access to the appropriate automated and human interventions. Consumers can discretionally engage (or escalate) the level of advise they need to gain confidence in their management of such issues. The brokerage can export the information and workup gained during an encounter to a subsequent tier of services.

There are various models for how consumers may gain access to the system. Consumers may purchase access to the system through a variety of models, including direct payment. Employers may purchase access to the brokerage for their employees e.g., via pension or 401K, 403K etc. plans. Providers may be compensated in several ways and may offer their services to the brokerage either independently or as part of a framework such as a provider network.

The brokerage provides compensation for products and services provided. Access to the system 100 may be provided on a subscription basis, with consumers paying a fee (either directly or indirectly through another party) to be provided with a particular level of access to the system. In exchange for providing products or services, the service provider may receive compensation from the consumer or from an organization that pays for the products or services on behalf of the consumer. In instances in which the consumer pays directly, the operator of the interface to the system that connected the consumer to the service provider may be compensated. In one embodiment, the consumer pays the operator, which keeps a portion (e.g., a percentage, a flat fee, or a co-pay) and pays the remainder to the service provider. In another embodiment, the consumer or the service provider pays a flat fee or percentage of the fee for the engagement to the operator.

### The Consumer Interface

Initiation of an Engagement

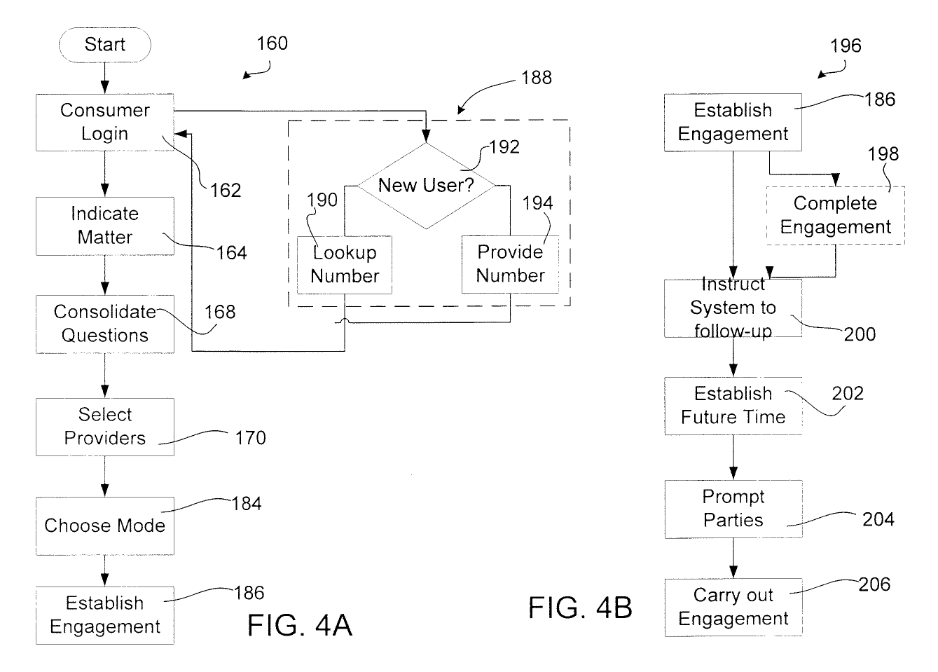

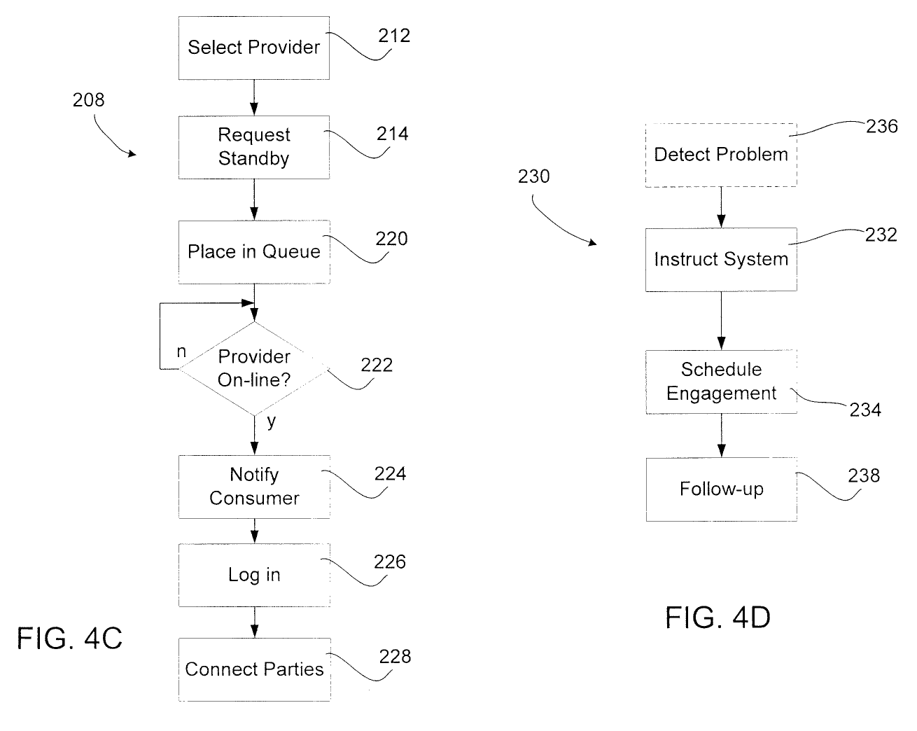

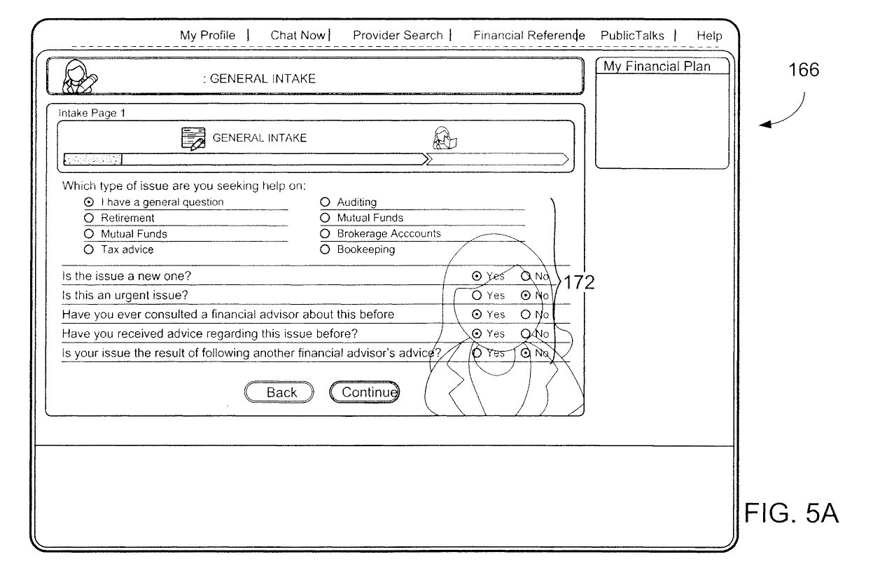

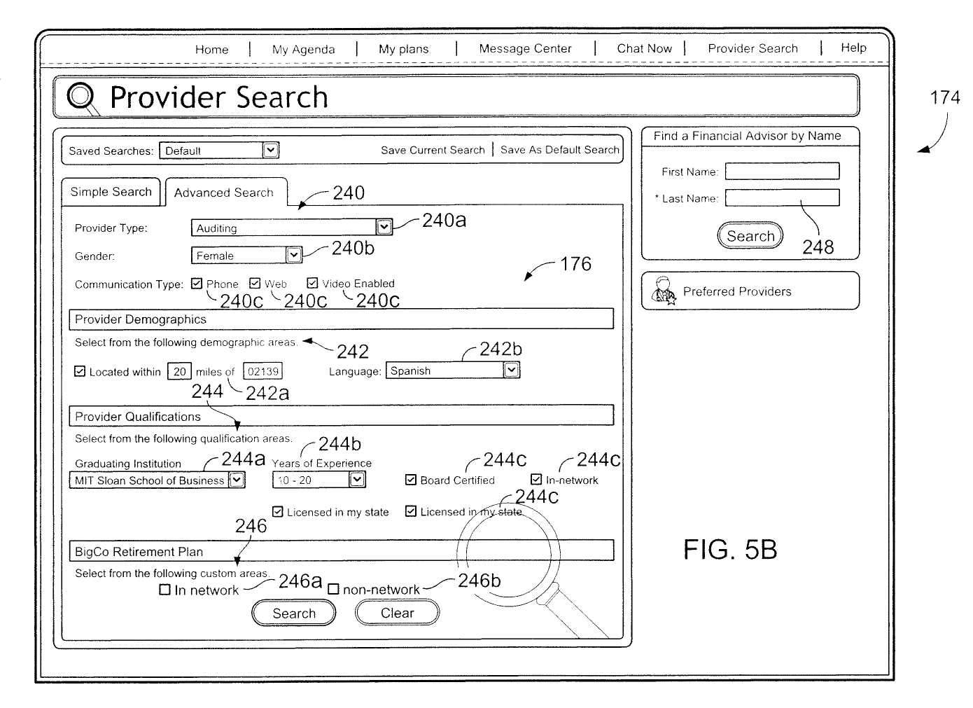

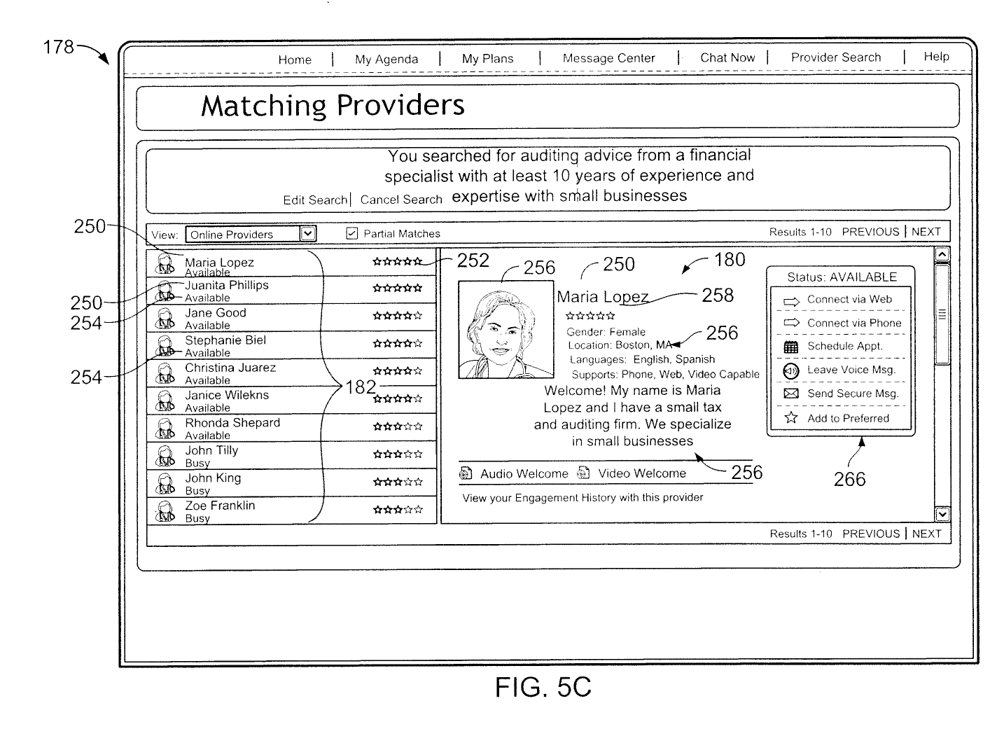

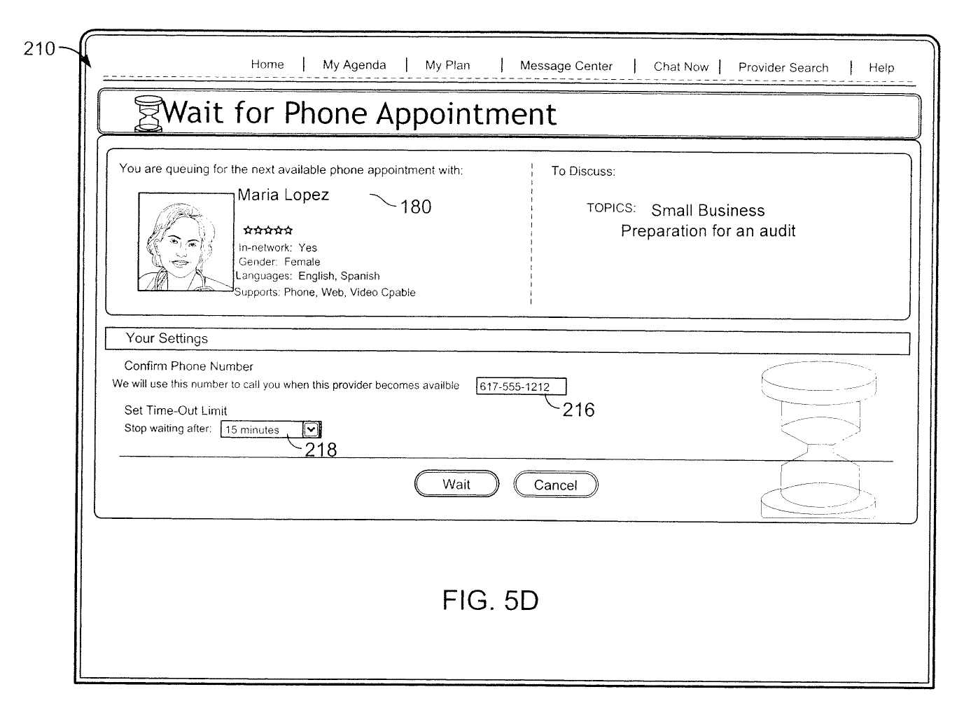

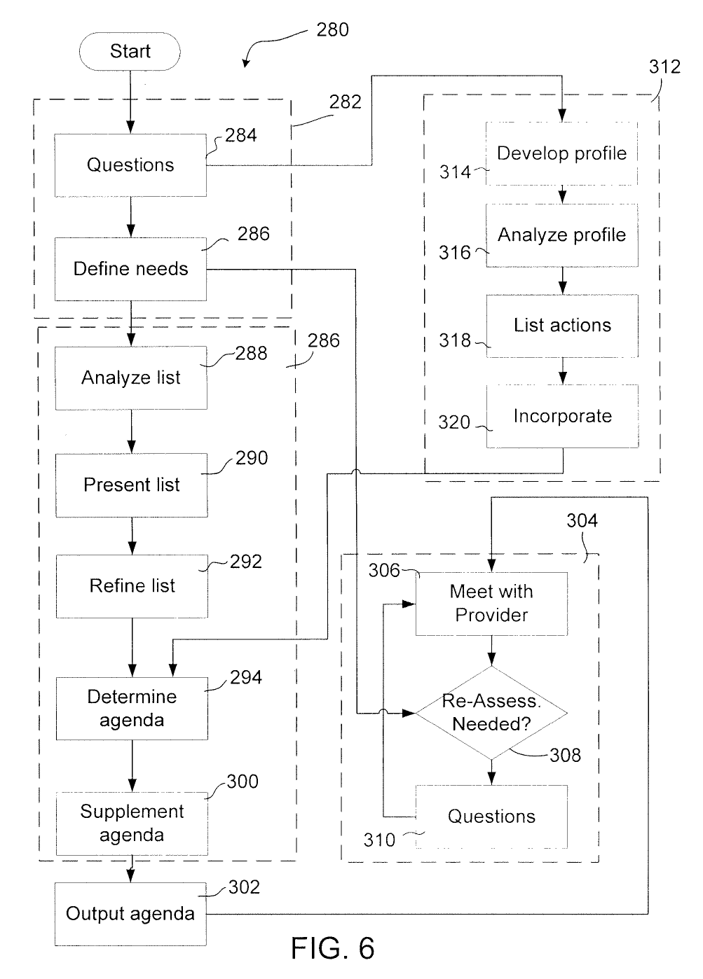

A consumer 120 engages with the brokerage system 100 to access a service provider 130. Several types of engagements may exist. Examples of these are described with respect to flowcharts in FIGS. 4A to 4D and user interface screens in FIGS. 5A to 5D.

Referring now to FIG. 4A, a process 160 for establishing a consumer-initiated engagement is shown. In a consumer-initiated engagement, a consumer logs in 162 and communicates 164 a new matter he desires assistance or guidance on to the brokerage. For example, this is done on a web page 166, as shown in FIG. 5A. A component of the brokerage system 100, such as the consumer advisor discussed below, assists the consumer in consolidating 168 his questions and helps select 170 the appropriate providers to answer them. The web page 166 includes some initial questions 172, and another web page 174, in FIG. 5B, provides a user interface for entering additional criteria 176 to find a provider. A results page 178, in FIG. 5C, allows the consumer to select a specific provider 180 from a list 182 of providers identified based on the search criteria. Once a provider is selected and a mode of engagement is chosen 184 (see below), the scheduling module 116 establishes 186 the new engagement. In some examples, the brokerage associates 188 a unique identifier with participating consumers which can be used in subsequent interactions with the brokerage, such as associating records from multiple engagements. The consumer's membership number or other similar, pre-existing identification can be used 190. If the consumer does not already have 192 a number, one is generated 194. The unique identifier can be used by the consumers to save their planned engagement for later retrieval.

Referring now to FIG. 4B, a process 196 for establishing a follow-up or prescheduled engagement is shown. Once an engagement is established 186 as in FIG. 4A or as one is completed 198, the two parties can instruct 200 a component of the system 100, such as the scheduling module 116, to pursue the established engagement or a follow-up engagement at pre-defined schedules or at future time points. The system uses 202 e-mail, automated telephone communication, or any other method of communication to establish a convenient time for both parties to accomplish the follow-up and then prompts 204 them to do so 206.

Referring now to FIG. 4C, a process 208 for a standby engagement is shown, with a user interface on a web page 210 in FIG. 5D. A standby engagement is similar to a consumer-initialized engagement. In a standby engagement, the consumer selects 212 a provider 180 or type of provider and requests 214 that a component of the system 100, such as the scheduling module 116, to notify the consumer by an appropriate communication, for example, e-mail, text message, or an automated phone call, when the selected provider is online and accepting engagements. In the example of FIG. 5D, the user has chosen to be called and input a phone number 216 and a limit 218 as to how long she will wait. The consumer request is placed 220 in a queue for the specific requested provider who is off-line (or for a type of provider for which all qualified providers are off-line). When the system determines 222 that the provider is available, the system notifies 224 the consumer. When notified, the consumer logs in 226 and is connected 228 to the provider.

As an option, a standby list for a provider may provide preferential queuing for some consumers. For example, preferential queuing may be provided based on prior engagements with the provider (e.g., preference is given to follow-up engagements) or based on a service tier (e.g., frequent user status) of that consumer. The brokerage can be configured such that it collects information about the consumer (e.g., answers to initial intake questions) and provides the collected information to the specific service provider prior to initiating any further engagements. For example, a consumer can store information during a consumer-initiated engagement as described above, park the information, and wait to be contacted when the specific selected provider is available.

Referring now to FIG. 4D, a process 230 for an interventional engagement is shown. In addition to consumer-initiated engagements, a plan such as a retirement plan (or another authorized entity) automatically instructs 232 the system to schedule 234 an engagement with one of its members. This scenario may be employed, for example, when a plan member is consuming 236 costly charges or exhibits a high risk score. The system may also be authorized to automatically pursue 238 a low-intensity telephonic follow-up with members that would otherwise not be contacted for follow-up.

Provider Selection

One capability of the brokerage is to extend a retail-like experience to the consumer. Consumers are able to spend time on the system to explore its participating providers whether they are currently available or are expected to be available at some other time. While the system can assist the consumer in identifying the most appropriate providers (see the consumer advisor function, below), it also allows the consumer to filter the provider list based on his preference and access a view of a provider availability matrix that changes as providers go on and off line.

An example of an interface by which consumers can select providers in a variety of ways is shown in FIG. 5B, mentioned above. Various criteria 176 can be used to filter the available providers. Basic details 240 indicate the consumer's preference for the type 240a and gender 240b of the provider and what modes of communication 240c the consumer wants to be able to use. The user can also specify demographics 242 including location 242a and languages spoken 242b. Qualifications 244 may include education 244a, years of experience 244b, and various other criteria 244c. The consumer's plan may offer additional searching criteria 246, such as whether a provider must be associated with a retirement plan 246a or whether the consumer can consult with an out-of-network provider 246b. A consumer can also use a search box 248 to search for a provider by name.

Consumers may select providers according to attributes of the provider, such as a geographical area where the provider is located or which professional organizations have accredited the provider. Any metrics within the provider profile (discussed below) can be used to define a list of providers that meet the consumer's preferences.

Once the consumer enters her search criteria 176, the results are shown on the web page 178 in FIG. 5C. As mentioned, a list 182 of providers is presented. This list may indicate each providers name 250 and rating 252 and whether the provider is available 254. For the selected provider 180, additional details are shown, including her picture 256, specialty 258, demographic information 260, what types 262 of connections she can use for an engagement, and personal information 264. Tools 266 allow the consumer to initiate or schedule an engagement. Providers already associated with the consumer may appear on the consumers' short list. Association may be based on historical engagements or financial plans, such as 401ks or other retirement plans. When reviewing the list of historical engagements, consumers are able to access the engagement audit and the ranking they have attributed to any engagements in the past.

Once a consumer has defined a collection of criteria to filter and find a provider, the system can offer tools to shorten the process in the future. Consumers may be able to save criteria-sets as named searches and benefit from notifications when a search list surpasses a certain level of availability that may encourage the consumer to log in and communicate with a provider.

Modes of Engagement

The brokerage allows consumers to engage provider's professionals “on demand” based on provider availability. Engagements can be established in various ways, including:
1. Passive browsing—Reference content is accessed on the brokerage's website. The website can support the use of licensed content packages from other vendors to meet the variable preferences of plans.
2. Financial Risk Assessments—The system acquires information from consumers through automated interaction (e.g., rules-based interaction) in order to crystallize their needs (e.g., financial risks) and better direct them. As assessments progress, the system constructs engagement suggestions that the consumer can exercise. Each suggestion represents both the question to the provider and the type of provider appropriate to answer it. Consumers may choose to simply launch such engagements or apply their own discretion as to the phrasing and the selection of the recipient provider. This is discussed in more detail below in the context of the consumer advisor.
3. Asynchronous correspondence—The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).
4. Synchronous correspondence—Several forms of synchronous correspondence allow the consumer and the provider to engage in real-time discussions.
5. Synchronous text correspondence—This may be referred to as a “Chat” module where both sides of the engagement type their entries in response to each others' entries. The form of communication may be entirely text based but is still a live communication. Examples include instant messaging and SMS messaging.
6. Web-based teleconferencing—The use of broadband network connections allows for real-time voice transmission over the Internet in what is referred to as full duplex (i.e., both voice channels are open at the same time). Consumers can opt to have a voice conversation with their providers using, for example, their computer's speakers and microphone. Web-based teleconferencing may use VoIP, SIP, and other standard or proprietary technologies.
7. Telephonic conferencing—Consumers who wish for a direct telephonic communication with a provider or who are not comfortable using their computer may use a traditional telephone for interaction with a provider. The consumer may use a dial-in number and an access code that connects him to the brokerage's servers. Providers are linked to the servers via VoIP, other data-network-based voice systems, or their own telephones. Telephonic conferencing may also allow consumers to request “call me now” functions, in which the provider calls the consumer (directly or through the brokerage).
8. Video conferencing—The system can support video conferencing to allow consumers to exhibit physical findings to providers if such disclosure is needed. Consumers and providers may also simply prefer face-to-face communication, even if remote. Small digital cameras, referred to as webcams, attached to or built in to personal computers or laptops can be used for this purpose. Video conferencing can be provided by standard software or by custom software provided by the brokerage. Alternatively, dedicated video conferencing communication equipment or telephones with built-in video capabilities can be used.
9. Semi synchronous correspondence—Some engagements of a consumer with an online provider include both synchronous and asynchronous interactions. Part of the engagement takes place by immediate messaging between the two, but the provider may ask the consumer to take occasional asynchronous assessments if, for example, a generic line of question is desired. This allows the provider to operate more than one consumer engagement at a time while each consumer is constantly engaged. For example, semi-synchronous correspondence includes a combination of e-mail, instant messaging, test messaging, voice calls and mail messaging, and VoIP calls and VoIP messaging.

Interactive Voice Response Engagements

Interactive Voice Response (IVR) systems allow for the deployment of interactive audio menus over the phone. The caller can navigate between options, listen to data-driven information, provide meaningful input, and engage system functions. IVR engagements extend the reach of the system to the telephone as a portable consumer interface to launch an engagement in addition to the Web-based interface. Consumers select a pin code on the application to authenticate their identity if they call in. Several types of engagements can be carried out through an IVR system using logic like that shown in FIG. 2B. For dial-in engagements, the consumer calls in and invokes a telephonic engagement with an available provider. The IVR system extends the consumer's ability to select a provider to the phone so that the consumer's interaction resembles one carried out on the Web.

The IVR system can also be used proactively to pursue consumers who need a second consultation. At the time of a second consultation, the system recalls the provider with whom the second consultation is desired (or the type of provider in case the follow-up is not restricted to a specific provider), identifies that the provider is available for an engagement, and attempts to contact the consumer over the phone to establish a connection for the engagement. Once contacted, the consumer can decline or ask to postpone the call. If the consumer takes the call, the connection is made. When consumers are pursuing an engagement with a provider that is either busy or currently offline (e.g., a specific provider or a type of provider with few participants), the IVR system allows the consumer to park in a standby mode until the provider is available. When the provider is available, the system calls the consumer, identifies the provider to the consumer, and verifies that the consumer is still interested in pursuing the call with the provider. If the consumer is still interested, an engagement is connected.

In addition to launching engagements, the IVR interface allows consumers to interact with other services offered by the brokerage. For example, consumers can instruct the system to fax a transcript of their information to a fax machine that the consumer identifies by keying in or speaking its phone number. Using such a function, a consumer makes key information available to personnel or to a provider in an office visit without the need to plan, collect, print, and carry the information to that encounter.

IVR hardware is readily available from telecommunication vendors and can be programmed to operate in the context of the brokerage framework. Authentication is provided through a PIN number or by other standard methods.

Engagement Auditing

In some examples, material elements of an engagement are audited by the brokerage to establish a work-up record of the consumer. Such a record of consumer entries, recordings, and provider notes, together with time stamps and identification of registrars, is available to the consumer at any time for future reference. A consumer may choose to share this record with other providers within the brokerage or to export it. Auditing may also include various degrees of automated entry of standardized coding to allow effective rule-based moderation of the system based on clinical (for example) insights captured during the engagement.

Engagement Recording and Transcription

The system 110 allows an engagement conducted using a voice technology, such as telephone, VoIP, or a video call over the web, to be recorded. As the system generates an audio file, it offers consumers services associated with the file. Based on a consumer request or setting to produce a transcript, the system forwards the file to a third party vendor to perform transcription of the file and return a textual representation of the engagement. Such text is incorporated into the consumer's record, communicated to an external party, or used as the basis for future engagements. In some examples, the transcription may be performed by voice recognition software. Transcription services can be bundled with encoding and translation services. The consumer may also request that the audio recording be made available over the phone or as a data file to a third party (e.g., the consumer's personal provider). In some examples, consumers are able to replay the recording from either the web client or a telephone as part of the IVR system.

Engagement Redirection

In some examples, a consumer redirects an active engagement to another provider or provider type. A consumer may also redirect an engagement to employ a different mode of communication with the current provider (e.g., move from a text chat to a phone conversation). The audit of the information and work up established before the redirection becomes the basis for the new engagement. In some examples, a consumer redirects an engagement that concluded in the past as a way to continue follow-up on the same issue.

### Consumer Advisor

Another utility in the brokerage, the consumer advisor, assists consumers in determining what actions to take, for example, which types of providers to consult. The consumer advisor acts as a facilitator of engagements between consumers and providers. In some examples, the consumer advisor is operated using a rule-driven engine embedded in the system 110 that draws from both consumer intake data and programmed knowledge. The consumer advisor helps the consumer identify issues that the consumer should discuss with a provider in the system, collects data to contextualize and shorten the time needed for the discussion, and helps orchestrate engagements with the appropriate type of providers, presenting the collected intake information to the providers prior to the commencement of the engagement itself.

The consumer advisor walks the consumer through the process of using the brokerage and helps the consumer acquire the appropriate services, minimizing the time spent and cost to the consumer in determining which services to use. In some examples, the consumer advisor packages or formats the information it has collected to export it to a non-virtual provider for further follow-up, even if the consumer did not end up in an engagement. The consumer advisor operates as an assistant to the provider during an engagement, working directly with the consumer.

Information Portability

The brokerage extends the result of any engagement to a physical point of care or service provider to allow continuation or escalation of services beyond those provided in the electronic encounter. For example, a textual transcript of an engagement is forwarded to a desired provider. If the provider is a participant in the brokerage, the provider accesses the transcript directly. If the provider is not a participant, other modes of access to the transcripts may be used, such as e-mail or fax or temporary access may be given to the non-subscribing provider. In some examples, the service may compensate a provider for reviewing a summary of his client's on-line engagement with another provider. This keeps the primary provider informed, leading to better service for the consumer, and making the eVisit system more palatable to the primary provider.

Assuring Continuity of Advice

Consumers are more likely to use the brokerage if they perceive it as a valid tier in their relationships with their service providers, which is more likely if there is continuity between engagements, whether live or on-line. The consultation performed on the brokerage facilitates the consumer's non-virtual relationship (rather than being redundant or contradictory) and thus encourages participation by both consumers and providers. The brokerage provides several features to achieve this goal. In some examples, the brokerage engages concierge practices in key geographic locations to provide non-virtual consultations to consumers who are otherwise managed only through brokerage-based engagements.

### Service Providers

Provider Enrollment

Service providers are the individuals responding to consumers queries and participating in engagements. For example, service providers participate in the brokerage while maintaining their affiliations they may have with any sort of professional engagement in the non-virtual world. Providers on the brokerage network are verified to hold their claimed credentials prior to being permitted to accept engagements with consumers. Once verified, providers agree to the terms of the brokerage, such as payment for their time in performing engagements, the protocol of conduct desired, and the ramification and distribution of liability in case of violations of that protocol. These are similar to the agreements providers would make when joining a group practice or a financial services firm in the non-virtual world. An example web page 330 for one stage in the enrollment process is shown in FIG. 8.

Prior to joining the brokerage network, a provider establishes a profile that allows consumers to select him as the target service provider of an engagement. Providers are profiled using verifiable information from provider registries. The profile is used for several purposes, including determining the relative cost of the provider's time to either the consumer or the brokerage sponsor (e.g. a retirement plan that is paying for the service), and providing consumers with information that may be relevant to their choice to engage one provider versus another.

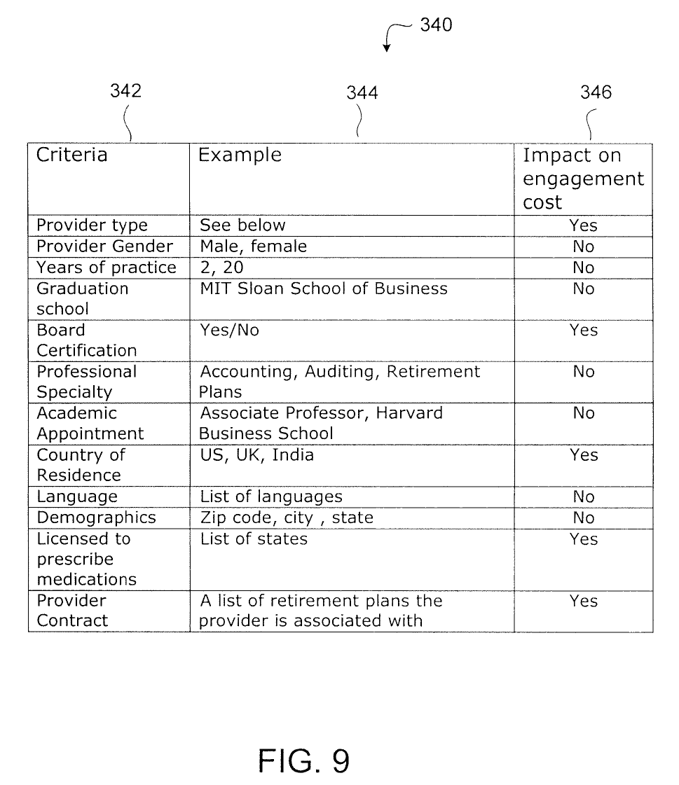

Some information about the provider is verified by the brokerage (e.g., Tax ID, education, professional certification, demographics, and contact information), and some is acquired during the provider's participation on the brokerage. Such data may include length of service, number of engagements, consumer satisfaction, projected availability, etc. A provider may also provide a general introductory note, a picture, and voice and video welcome snippets. Providers may also add other information they deem relevant for consumers (e.g., a list of publications and honorary appointments). A table 340 in FIG. 9 lists example profiling criteria that can be populated during enrollment in a financial services context. The table 340 includes example criteria 342, specific examples 344 of each criterion 342, and an indication 346 of whether that criterion would have an impact on engagement cost.

Providers participating in the brokerage may come from one or more networks of service providers. Individual service providers are also able to register and enroll with the system. Individual service providers may be independent service providers not affiliated with a provider network (e.g., a retirement plan), or service providers affiliated with a provider network that is not itself affiliated with the brokerage. This allows service providers (or other service provider networks) outside of a selected service provider network to participate in the system.

Provider Introduction

As part of the provider selection process described above, consumers benefit from access to introductory material from the provider. As consumers search for providers to meet their needs, they can select to view only providers where such material is available, producing an incentive for providers to take advantage of such capability. The example page 330 in FIG. 8 allows a provider to upload such information. Introductory material may include the provider's picture 332, a text welcome 334, a welcome recording 336, a video introduction 338, or a link (not shown) to the provider's home page in a tax firm, accounting firm or brokerage firm, for example.

### Provider Ratings

To further improve the ability of consumers to choose appropriate service providers, the brokerage includes a utility for rating the products and services provided by the service providers or by a service provider network. The consumers provide feedback (positive and negative) to the system about the products and services provided by a particular service provider in addition, the service providers provide feedback and evaluations of the products and services provided by other service providers.

In some examples, this information is used to reconsider the certification of service providers participating in the system. Periodically, the system performs a re-evaluation process on each of the service providers participating in the system and eliminates or locks out service providers that do not meet certain criteria or a minimum level of performance with respect to consumer and peer evaluations. Newer service providers are enrolled to participate in the system for a probationary period where they are allowed to continue only if the evaluations of their products and services are satisfactory or are above a predefined threshold for performance.

As part of the provider profile (and as a way for consumers to limit their search), the system continuously updates each provider's profile with metrics reflecting the quality of his or her interaction with consumers. The metrics are updated at the conclusion of every engagement to allow providers immediate feedback as to their level of service. In some examples, all searches for providers on the system are sorted by provider rating by default, promoting higher-quality providers. Example parameters to be updated and taken into account in setting the rating include consumers' overall ranking of the provider's engagement quality, the number of engagements made by this provider in the last 30 days or overall, the number of returning engagements as a fraction of all engagements for that provider, the number of redirected engagements from this provider to another, and the average turnaround time for messaging while not “out-of-office.” In addition to the ratings each provider on the system has a Provider Statistic Manifest stating operational statistics that may interest consumers, such as that provider's availability for phone conferences over the last 30 days.

Consumers are asked to rank a provider at the end of the engagement as part of the process of disconnecting. To encourage consumers to provide such feedback, charges for the engagement continue to accrue until the consumer completes the ranking. Such a process helps encourage provider engagements to end with a ranking entry, promoting a higher quality of service to the brokerage's consumers.

The Provider Console

Providers interact with consumers through a provider console web page 350, shown in FIG. 10. This interface is similar to that used by the consumers. The provider console provides access to the various tools used by providers. A window shows a live image 352 of the consumer, with tools 354a, 354b to control or disable the video feed. A phone control 356 allows the provider to initiate a phone call with the consumer. A log of an ongoing chat 358 is displayed above an input 360 for the provider's next comment. Other tools are available in tabs 362 on the side, such as accesses to the terms of operation and the legal policies of the brokerage, such as disclaimers. State setting allows the providers to change his availability state between states such as off-line, on-line and out-of-office. Scheduling allows providers to update their availability calendar with future times they expect to be available on the system, which can in turn result in consumers seeing a “scheduled” state for such providers.

Messaging tools allow providers correspond with consumers in message-based engagements. The console also allows the provider to participate in chat engagements where the consumer and the provider communicate back-and-forth in real-time by typing, such as the chat 358 in FIG. 10. The brokerage allows a single provider to engage in more than one chat at a time to maximize his yield while consumers are typing their entries. The chat feature also allows the provider to forward specific lists of questions to further reduce the need for his time in acquiring information from the consumer at the beginning of an engagement. Tools available to assist the provider in chat or messaging may include a thread viewer, a clinical summary of the consumer, the consumer's engagement history, a communication timeline chart, and a library of built-in and self-produced message templates for quick response. Such templates may also include references, links, and embedded graphical educational content on prevalent topics. In some examples, the brokerage scans outbound messages for inappropriate language based on the sponsor's preferences.

The console allows the provider to hold a voice conference engagement with the consumer when the consumer is using either her computer or a telephone. The provider can use the console to redirect his end of the conference to a phone, for example, if bandwidth or other considerations indicate it or simply based on personal preference. The console also allows the provider to engage in video conferences with consumers. Audio may be served via the console or be may redirected to a telephone. To verify a provider's identity when using the telephone for a voice engagement, the system provides the provider with a PIN number through the provider console. When the provider calls into the system, or answers the phone when called by the system, the provider enters the PIN to confirm that the person on the phone is the same person who is logged into the console. This method is also used to leave secure voice message. When a provider wants to leave a message for a consumer, the provider tells the console and receive a PIN. The provider then receives a call from the system, enters the PIN, and leaves a message. The message is then delivered to the consumer with assurances that it was left by the provider.

At any time during an engagement, the provider may add notes to either the consumer engagement audit (consumer record) or to his own audit of the engagement. The audit trail allows the provider to review a complete audit of his consumer interactions via the console. This audit may include the content and timing of past engagements and related credits that the provider is due for the engagements.

In versions of the brokerage for fields, such as accounting, tax and the financial services sector, that rely on detailed coding of work performed or analyses made, an encoder feature is provided throughout the engagement. The encoder allows the provider to add clinical codes describing the findings of the engagement. The codes can be used to further characterize the consumer as well as the basis for outbound communication to the follow-on points of care or interfaced clinical systems. The encoder can support, for example, coverage for disease, drug and procedure classifications.

The system may allow provider to provider interaction either in the context of a consumer (e.g., consultation or referral) or without a consumer context (e.g., provider forums, discussion boards, etc.). Assuming it is authorized, the provider may instruct the system to forward transcripts of engagements or other information to another recipient outside the brokerage. Such exporting may include various modes of communication, such as electronic (e.g., fax, e-mail, SMS) or non-electronic (e.g., print, mail).

The provider is able to review his account status, system settings, and preferences. The provider can also access his profile and user satisfaction and statistics as they are available to consumers. The console also connects to financial services associated with the provider's participation in the brokerage.

The brokerage offers providers the ability to redirect messages or requests for appointment to SMS-compatible cellular phones. In this mode, the provider associates a cell phone number with his account and establishes the type of information that the system can send to the mobile device. Such information may include engagement-related notifications as well as system-related notifications (e.g., an announcement about a high-traffic state asking providers to make themselves available and offering a higher fee to do so).

### Open Access Forum

In some examples, the system includes an open forum that supports freeform engagements on different topics between all constituents. The open forum allows a consumer to anonymously post any of the issues identified by the consumer advisor or to manually post questions into a publicly-accessible forum. While the consumer posts his issues anonymously, responses or threads developing as other users provide answers or discuss the issues are forwarded to the consumer that posted the original issue. In some examples, the system monitors the identity of those who respond to a posting and differentially informs the consumer if a user known to be a provider posts a response. In some examples, the brokerage pays providers to post responses to entries they think are significant on the open forum. Unlike consumer entries, provider entries are identified and allow a consumer to start engagements with providers whose answers he finds informative or beneficial. The open forum also serves as a vehicle for providers to publicize themselves to consumers.

In some examples, a consumer posts the audit of one or more engagements onto the open forum for the benefit of other consumers. The brokerage strips any data that identifies the participants (i.e., it annonymizes the data) and offers the consumer the ability to review the anonymized data prior to posting it.

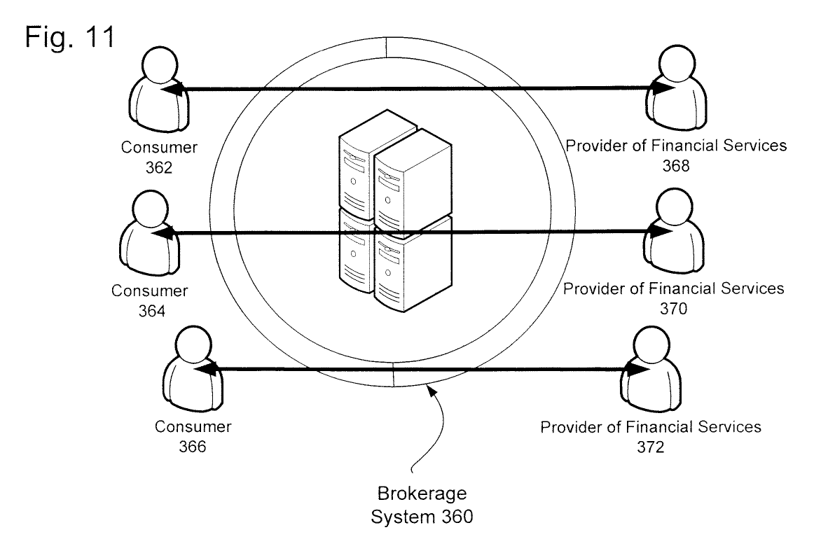

Referring to FIG. 11, the brokerage system 360 connects consumers of financial services 362, 364, 366 with providers of financial services 368, 370, 372. One of the advantages of the brokerage system 360 is that it provides a live interaction between a provider of financial services and a consumer. The brokerage system 360 connects consumers with providers of financial services in various ways.

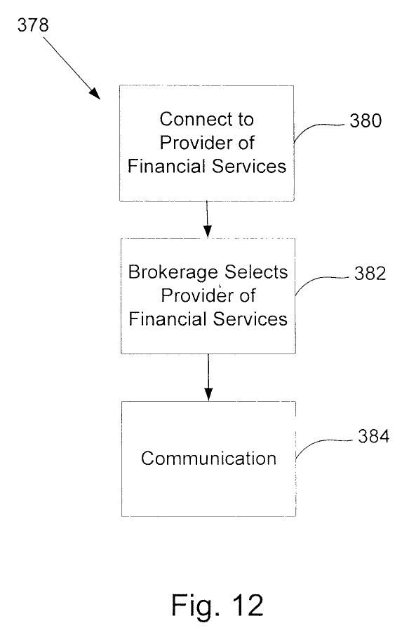

Referring to FIG. 12, consumers are directly connected to providers of financial services. In a direct connection 378, a consumer chooses to directly and immediately connect to a provider of financial services 380, the brokerage system selects a provider of financial services 382, and the brokerage initiates a communication between the consumer and the provider of financial services. In some examples, the consumer chooses to directly connect to a provider of financial services through a web interface by selecting a hyperlink or a virtual web button that initiates the communication between the consumer and the provider of financial services through the brokerage system 360.

In a direct connection 378, the consumer does not specify the type of financial services provider with whom the consumer wishes to converse or the reason for the communication. Therefore, the brokerage system 360 includes a list of service providers who are general providers of financial services and are therefore capable of assisting consumers in a wide variety of topics. When a consumer initiates a direct connection 378, the brokerage system 360 selects a general provider of financial services to consult with the consumer.

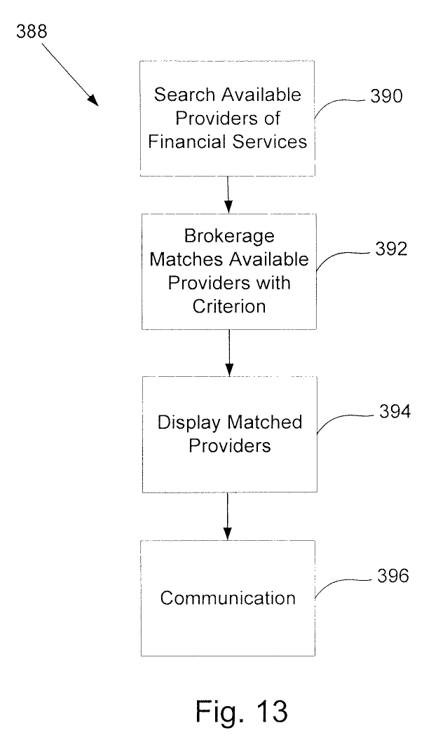

Referring to FIG. 13, consumers are search connected 388 to providers of financial services. In a search connection 388, a consumer searches for available providers of financial services 390 by entering or selecting varying criterion, the brokerage system matches available providers of financial services with the entered criterion 392, the brokerage system provides the consumer with a list of providers of financial services satisfying the entered criterion 394, the consumer selects a provider of financial services (not shown) and the brokerage system initiates a communication between the consumer of services and the provider of financial services 396.

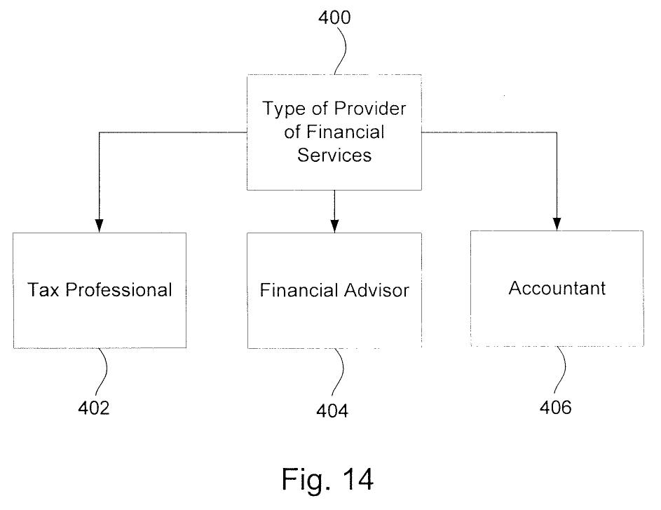

A consumer searches for available providers of financial services 390 (FIG. 13) based on various criterion, including—but not limited to—the type of provider of financial services or the geographical location of the provider of financial services. Referring to FIG. 14, a consumer's search includes the type of providers of financial services 400, including tax professionals 402, financial advisors 404 and accountants 406. In some examples, these selections are provided to a consumer in a web-based interface that include drop-down boxes for the consumer to select the type of service provider 400.

Referring to FIG. 14, a consumer may choose to consult with a tax professional 402. The brokerage system enables a consumer to refine a search for a provider of financial services by presenting areas of expertise for a specific type of provider of financial services.

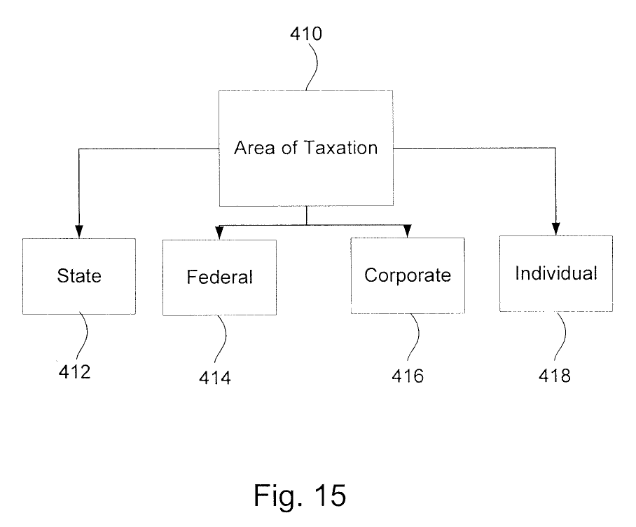

In this case, the brokerage system requests from the consumer additional information about the specific area of taxation in which the consumer is requesting a consultation. Referring to FIG. 15, the brokerage system 360 provides a graphical user interface that when rendered on a display displays the various areas of taxation 410, including state tax 412, federal tax 414, corporate tax 416 and individual tax 418. In another example, a consumer selects to consult with a financial advisor 404.

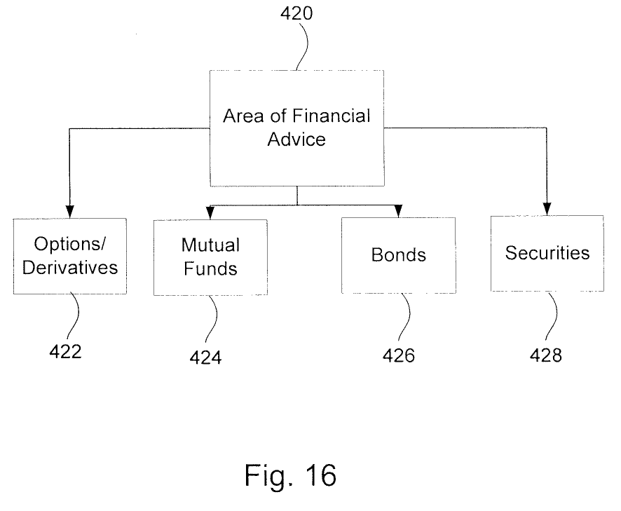

Referring to FIG. 16, the brokerage system 360 provides a graphical user interface that when rendered on a display displays the various areas of financial advice 420, such as options and derivatives 422, mutual funds 424, bonds 426, and securities 428.

Based on the user's search criterion, such as selecting a financial advisor in the area of mutual funds, the brokerage system matches providers of financial services meeting the consumer's criterion 392 and presents a listing of the available providers of financial services to the consumer 394. The brokerage system 360 performs the matching by maintaining pools of providers of financial services in various financial services specialties. For example, the brokerage system includes a listing of available financial advisors 404 specializing in options and derivatives 422. The brokerage system 360 includes a second listing of available financial advisors 404 specializing in mutual funds 424, a third listing of available financial advisors 404 specializing in bonds 426 and a fourth listing of available financial advisors specializing in securities 428 and so forth. These listings are updated when a provider of financial services logs into or out of the brokerage system. After the consumer selects a provider of financial services, the brokerage system 360 initiates a communication 396 (FIG. 13) between the consumer and the provider of financial services.

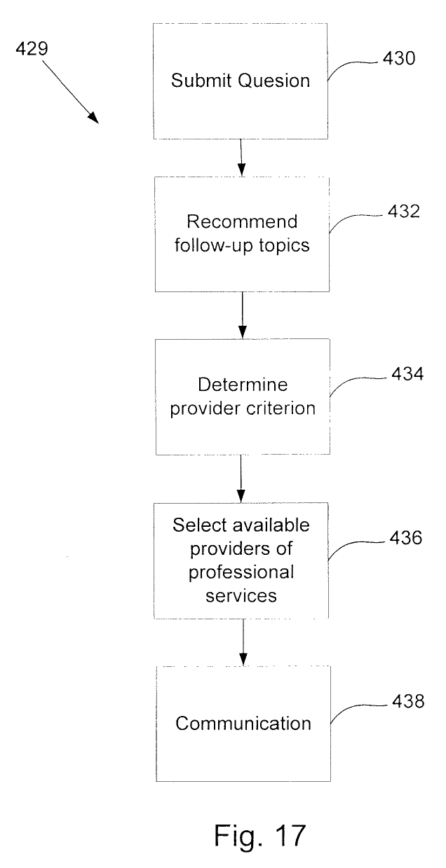

Referring to FIG. 17, in an assessment search 429, the consumer submits a question to the brokerage system 430 or answers a series of questions presented by the brokerage system. Based on the consumer's questions or answers, the brokerage system recommends follow-up actions 432, determines the criterion of a provider best suited to assist the consumer 434, and selects available providers of financial services who meet the criterion 436. The consumer is presented with the list of available providers of financial services generated by the brokerage system and selects a provider of financial services (not shown). Upon selection, the brokerage system initiates a communication 438 between the consumer and the provider of financial services.

When a consumer submits a question 430 to the brokerage system, a search function included in the brokerage system scans the submitted question for certain keywords, words that indicate the type of consultation the consumer is seeking. For example, key words include—but are not limited to—terms such as audit, tax, mutual funds, stock and accounting.

Based upon the key words contained in the consumer's question, the brokerage system identifies a number of follow-up actions and topics the consumer may be interested in reading and recommends these topics and related materials to the consumer 432 (FIG. 17).

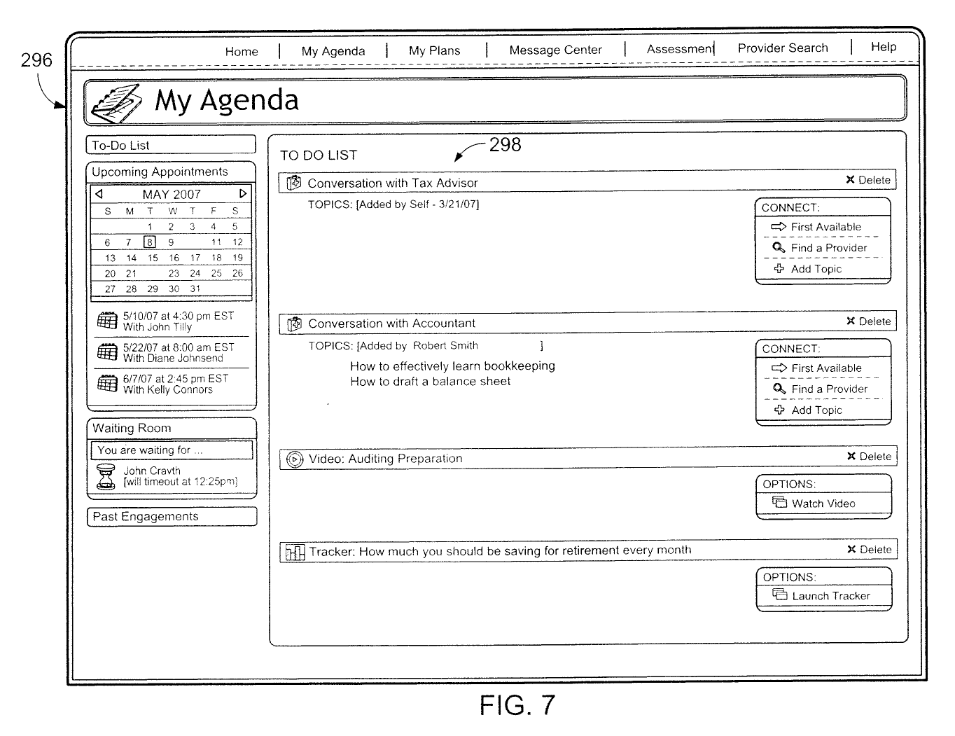

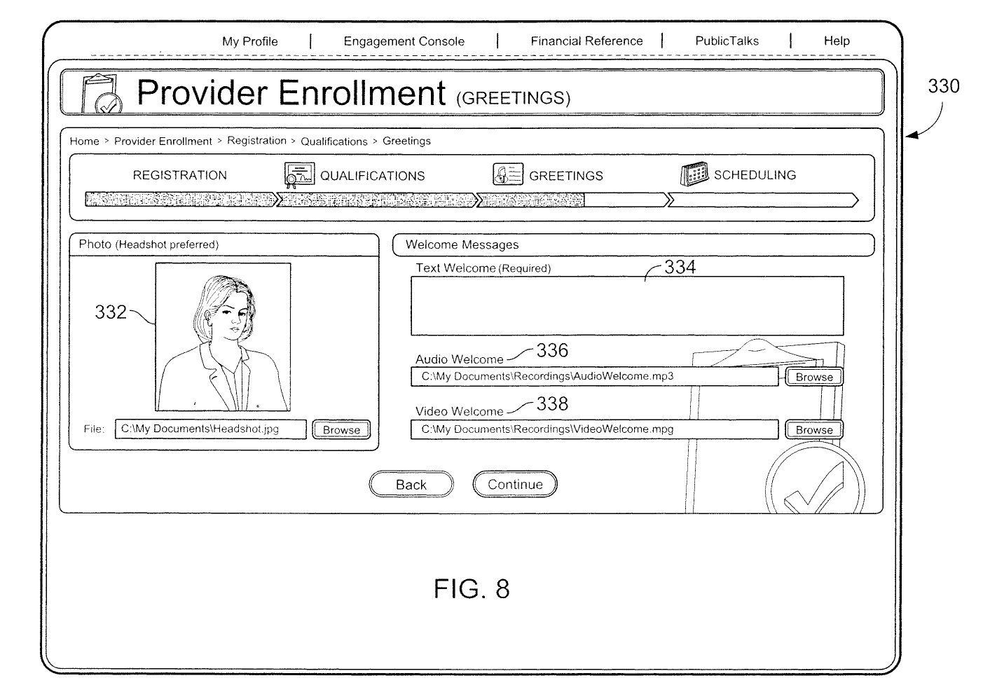

Referring to back to FIG. 7, these topics may be inserted into an agenda 298 that is displayed in a user interface. Based upon the keywords contained in the consumer's question, the brokerage system also determines the criterion for a provider of financial services that is best suited to answer the consumer's question or provide a consultation 434 (FIG. 17). For example, if the consumer entered into the brokerage system a question about how to short securities, the brokerage system would determine that the words “short” and “securities” were keywords. Based on these keywords, the brokerage system would recommend the consumer consult with a financial advisor specializing in securities 428 (FIG. 16). Once the brokerage system has determined the criterion for provider of financial services that is best suited to answer the consumer's questions, the system selects available providers of financial services matching the criterion 436 (FIG. 17).

The brokerage system is capable of initiating various types of communications between the consumer and the provider of financial services. In one example, through the brokerage system the consumer schedules an appointment with a provider of financial services. In this case, the appointment with the provider of financial services is inserted into the consumer's agenda 298 (FIG. 7). In another example, the consumer waits in a virtual waiting room to see for the provider of financial services. In another example, the brokerage system initiates a real-time communication between the provider of financial services and the consumer of financial services.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprises:
brokering a real-time communication between a consumer of services and a provider of financial services using a brokerage system on a computer by:
receiving a request from the consumer of services to consult with a provider of financial services;
identifying an available provider of financial services; and
activating a communication channel between the consumer of services and the available provider of financial services.

2. The computer-implemented method of claim 1 further comprises:
providing a first graphical user interface that when rendered on a display displays for the consumer types of available providers of financial services.

3. The computer-implemented method of claim 2 further comprises:
receiving a request from the consumer of services to consult with a selected type of provider of financial services; and
providing a second graphical user interface that when rendered on the display displays for the consumer areas of specialization for the selected type of provider of financial services.

4. The computer-implemented method of claim 1 wherein identifying an available provider of financial services further comprises:
monitoring availability of the providers of financial services.

5. The computer-implemented method of claim 1 wherein receiving a request from the consumer of services to consult with a provider of financial services further comprises:
receiving a request from a consumer of services to consult with a provider of financial services having a provider profile that satisfies at least some attributes in a set of attributes that define a suitable provider of financial services.

6. The computer-implemented method of claim 1 wherein receiving a request from the consumer of services to consult with a provider of financial services further comprises:
receiving a message from a consumer of services;
parsing the contents of the message; and
identifying a type of provider of professional services to consult with the consumer based on the results of the parsing.

7. The computer-implemented method of claim 1 wherein the provider of financial services includes an account, a tax professional, or a financial advisor.

8. A computer program product residing on a computer readable medium for providing broker services to consumers and providers of financial services, the computer program product comprising instructions for causing a computer to:
receive a request from the consumer of services to consult with a provider of financial services;
identify an available provider of financial services;
activate a communication channel between the consumer of services and the provider of financial services; and
broker a real-time communication between a consumer of services and a provider of financial services using a brokerage system included on a computer.

9. The computer program product of claim 8 further comprising instructions for causing a computer to:
provide a first graphical user interface that when rendered on a display displays for the consumer types of available providers of financial services.

10. The computer program product of claim 9 further comprising instructions for causing a computer to:
receive a request from the consumer of services to consult with a selected type of provider of financial services; and
provide a second graphical user interface that when rendered on the display displays for the consumer areas of specialization for the selected type of provider of financial services.

11. The computer program product of claim 8 wherein instructions for causing a computer to identify an available provider of financial services further comprises instructions for causing a computer to:
monitor availability of the providers of financial services.

12. The computer program product of claim 8 wherein instructions for causing a computer to receive a request from the consumer of services to consult with a provider of financial services further comprises instructions for causing a computer to:
receive a request from a consumer of services to consult with a provider of financial services having a provider profile that satisfies at least some attributes in a set of attributes that define a suitable provider of financial services.

13. The computer program product of claim 8 wherein instructions for causing a computer to receive a request from the consumer of services to consult with a provider of financial services further comprises instructions for causing a computer to
receive a message from a consumer of services;
parse the contents of the message; and
identify a type of provider of professional services to consult with the consumer based on the results of the parsing.

14. The computer program product of claim 8 wherein the provider of financial services includes an account, a tax professional, or a financial advisor.

15. An apparatus comprising:
a processor; and
a computer program product residing on a computer readable medium for providing broker services to consumers and service providers, the computer program product comprising instructions for causing the processor to:
receive a request from the consumer of services to consult with a provider of financial services;
identify an available provider of financial services;
activate a communication channel between the consumer of services and the provider of financial services; and
broker a real-time communication between a consumer of services and a provider of financial services using a brokerage system included on a computer.

16. The apparatus of claim 15 further comprising instructions for causing a processor to:
provide a first graphical user interface that when rendered on a display displays for the consumer types of available providers of financial services.

17. The apparatus of claim 16 further comprising instructions for causing a processor to:
receive a request from the consumer of services to consult with a selected type of provider of financial services; and
provide a second graphical user interface that when rendered on the display displays for the consumer areas of specialization for the selected type of provider of financial services.

18. The apparatus of claim 15 wherein instructions for causing a processor to identify an available provider of financial services further comprises instructions for causing a processor to:
monitor availability of the providers of financial services.

19. The apparatus of claim 15 wherein instructions for causing a processor to receive a request from the consumer of services to consult with a provider of financial services further comprises instructions for causing a processor to:
receive a request from a consumer of services to consult with a provider of financial services having a provider profile that satisfies at least some attributes in a set of attributes that define a suitable provider of financial services.

20. The apparatus of claim 15 wherein instructions for causing a processor to receive a request from the consumer of services to consult with a provider of financial services further comprises instructions for causing a processor to:
receive a message from a consumer of services;
parse the contents of the message; and
identify a type of provider of professional services to consult with the consumer based on the results of the parsing.

21. The apparatus of claim 15 wherein the provider of financial services includes an account, a tax professional, or a financial advisor.
